(19) United States
(12) Patent Application Publication
(10) Pub. No.: US 2012/0036214 A1
(43) Pub. Date: Feb. 9, 2012

(54) ALTERNATIVE TRANSFER OF LOGICAL PARTITIONS (LPAR) FROM ONE LPAR COMPUTER SYSTEM TO ANOTHER

(75) Inventors: James A. Pafumi, Austin, TX (US); Veena Ganti, Austin, TX (US); Morgan J. Rosas, Austin, TX (US); Vasu Vallabhaneni, Austin, TX (US)

(73) Assignee: International Business Machines Corporation, Armonk, NY (US)

(21) Appl. No.: 12/849,655

(22) Filed: Aug. 3, 2010

(51) Int. Cl. G06F 15/167

(52) U.S. Cl. 709/215

(57) ABSTRACT

An alternative migration of an LPAR from one server system to another when either or both of the server systems cannot access a Storage Area Network (SAN) or like external storage network. If said source and destination server system do not have access to the same SAN, then a mirror image of said all data storage supporting the transferred LPAR is created and transmitted to local storage supporting the destination server system and then the logical partition (LPAR) is transmitted over the connecting network from the source server system to the destination server system.

### TECHNICAL FIELD

The present invention relates to Logical Partitions (LPAR) computer systems and particularly to the transfer or migration of a LPAR from one computer system to another.

### BACKGROUND OF RELATED ART

A Logical Partition (LPAR) is a portion of a computer system's physical resources virtualized to perform as a separate virtual computer in a LPAR computer environment. The LPAR unit determines its logical partitioning function and its mode of operation. Currently, LPAR implementations have been effectively used in server controlled computer systems, such as the pSeries Power systems.

Even relatively small server controlled systems host many LPARs. As the number of hosted LPARs increases, finding maintenance windows acceptable to all of the LPARs in a server controlled system becomes increasingly difficult. Thus, the ability to transfer, i.e. migrate, partitions between server controlled LPAR systems without disrupting the running of operating systems and hosted application programs has become an necessity. Such partition mobility allows users to distribute partitions between server systems so that previously disruptive operations may be performed on selective machines at the user's convenience rather than when such operations cause the least inconvenience to others.

A particularly effective form of LPAR mobility has been Live Partition Mobility developed by International Business Machines Corporation (IBM), which is described in the publication, IBM PowerVM Live Partition Mobility, John E. Bailey et al, March 2009, which may be obtained at ibm.com/redbooks, particularly at pp. 1-14. This partition mobility permits the migration or transfer of partitions that are running AIX and Linux operating systems, including hosted applications from one physical server system to another without disrupting any infrastructure services. The migration transfers the whole partition system environment including the processor state, memory, attached virtual devices and connected users. Thus, systems partitions may undergo maintenance and modification without disruption.

While this capability to readily move partitions has given the information processing industry tremendous flexibility in balancing workload between server systems, it does require that the source and destination systems of the partition being transferred be able to access an external storage from which the mobile partition's operating system, applications and associated data are available. This external storage system and network has been standardized by the computer industry as the Storage Area Network (SAN) technology. The SAN is essentially a high speed special purpose network that interconnects a variety of storage devices associated with user server systems in support of the networks interconnecting the server systems.

While a great number of current LPAR systems do have access to SAN or like external storage networks, there remain many user LPAR system that do not have such access. The present invention offers the users of such LPAR systems, not connected to SAN, an alternative for the transfer of LPARs.

### SUMMARY OF THE PRESENT INVENTION

The present invention provides an implementation for alternative migration of a LPAR from one server system to another when either or both of the server systems cannot access a SAN or like external storage network.

In its broadest aspect, the present invention involves an implementation for transferring a logical partition (LPAR) from a source server controlled computer system to a destination server controlled computer system over a connecting network that comprises first determining if the source server system and the destination server system have access to the same SAN. If both server systems have such access, then a standard live partition mobility transfer of the LPAR is made by transmitting the LPAR over the Ethernet, i.e. a connecting network such as the Internet, from the source server system to the destination server system along with transmitting all data storage supporting the LPAR from the source server system to the destination server system over the external SAN.

On the other hand, if the source and destination server system do not have access to the same SAN, then a mirror image of all data storage supporting the transferred LPAR is created and transmitted to local storage supporting the destination server system; then the LPAR is transmitted over the connecting network from the source server system to the destination server system.

In the implementation, the mobile LPAR is transmitted over the connecting network using iSCSI protocols and the mirror image of all data storage supporting said LPAR is transmitted over a network using iSCSI protocols.

As will be hereinafter set forth in greater detail, prior to the creating of the mirror image, it should be determined that said local storage supporting the destination server system is capable of storing the mirror image. Accordingly, a preferred implementation, upon a determination that the destination server has such supporting storage, comprises accessing by the destination server system using iCSCI protocols, the data storage at the source server supporting the transferred LPAR wherein the source server data storage is treated as a target device of the destination server; then, creating said mirror image and transmitting the mirror image over the network using said iSCSI protocols.

The present invention may be used for systems in which the source server and the destination server are Virtual I/O Servers (VIOS), as well as for systems in which the source and destination server systems are Central Electronics Complex (CEC) servers.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized diagrammatic view of a network portion to illustrate the transfer of a mobile LPAR from one server system to another;

FIG. 2 is a generalized diagrammatic view of a network portion to illustrate the transfer of a mobile LPAR from one server system to another using the alternative transfer implementation of the present invention;

FIG. 3 is an illustrative simplified diagrammatic view of a control processor that may be used for the hypervisors of the server systems of FIGS. 1 and 2;

FIG. 4 is a general flowchart of a program set up to implement the present invention for the transfer of a mobile LPAR from one server system to another using the alternative transfer implementation;

FIG. 5 is a general flowchart of a program set up to implement the present invention for the specific creation and transmission of the mirror image of the data storage of the LPAR being transferred; and

FIG. 6 is a flowchart of an illustrative run of the programs set up in FIGS. 4 and 5 for the alternative LPAR transfer of the present invention.

### DETAILED DESCRIPTION OF THE PREFERRED EMBODIMENT

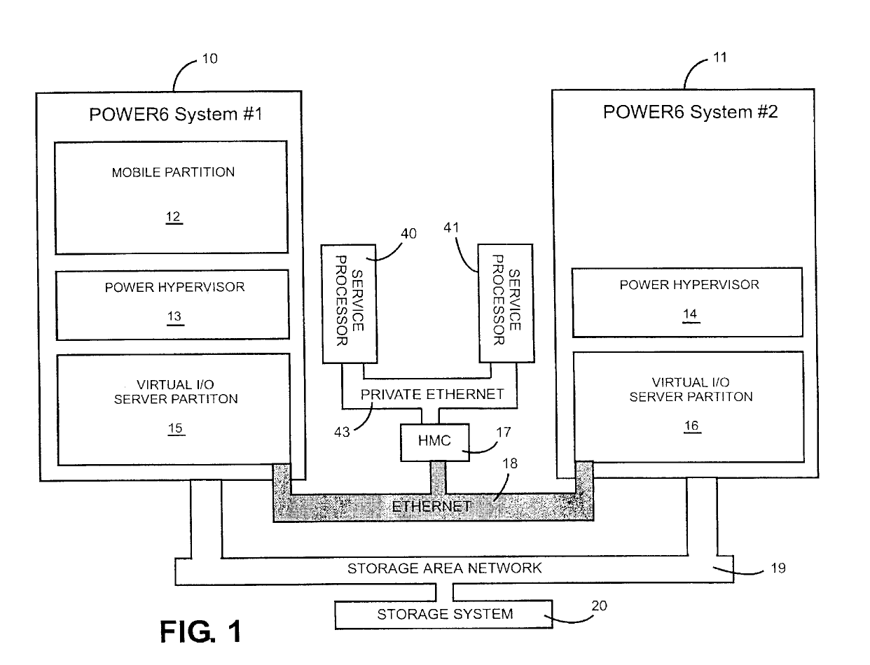

Referring to FIG. 1, there is shown a generalized diagrammatic view of a network portion illustrating the live transfer of a mobile LPAR 12 from a source server system 10 to a destination server system 11. The system involved in this embodiment is the Power6™ System marketed by IBM as described in the above-mentioned publication, IBM PowerVM Live Partition Mobility, John E. Bailey et al, March 2009, which may be obtained at ibm.com/redbooks, particularly at pp. 1-14.

The respective server operations are respectively controlled by Hypervisors 13 and 14 through their respective servers, VIOS partitions 15 and 16, i.e. each of the source 10 and destination 11 systems is respectively configured with a single Virtual I/O Server partition 15 and 16. The transfer of mobile partition 12 from system 10 to system 11 over an Ethernet 18, such as the Internet, uses iSCSI protocols and is coordinated by Hardware Management Console (HMC) 17. The transfer may also be made via a private ethernet 43 through respective service processors 40 and 41, respectively, servicing systems 10 and 11 and coordinated by HMC 17. However, the key to this mobile transfer is that both source system 10 and destination system 11 must be able to access, through their respective virtual server partitions 15 and 16, an external storage system: the SAN 19 that is supported by a storage system 20.

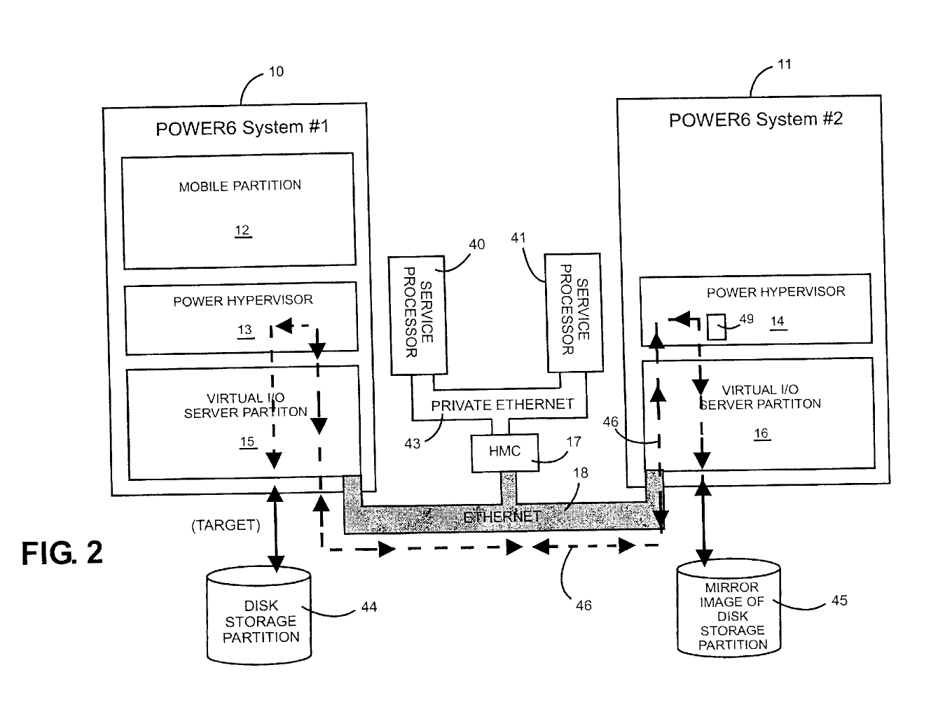

The present invention, which will be described with respect to FIG. 2, provides for an alternative LPAR transfer implementation for situations wherein either or both of the source and destination systems cannot access the external storage, i.e. SAN 19. When a transfer of the mobile partition is initiated, as described with respect to FIG. 1, and it is determined that either of the source 10 or destination 11 servers cannot access storage area network SAN 19, a routine 49 is initiated via hypervisor 14, in destination server system 11, FIG. 2, wherein the destination server accesses via a path 46, illustrated by a dashed line, the storage 44 supporting mobile partition 12. After first determining that there is local storage at the destination server capable of storing a mirror image 45 of storage 44, the destination server 11 accesses the storage supporting partition 12 via path 46 through connecting network 18 and source server hypervisor 13 using iSCSI protocols wherein the virtual disk storage 44 supporting mobile partition 12, controlled by VIOS server partition 15, is treated as a target device. A mirror image of disk storage 44 is created and transmitted back via path 46 through connecting network 18 and destination server hypervisor 14 using iSCSI protocols wherein the mirror image of disk storage 44 supporting mobile partition 12, controlled by VIOS server partition 15, is now stored in local storage 45 of destination server system 11 and is now available to support mobile partition 12 that can now be transmitted via connecting network 18 using iSCSI protocols.

Accordingly, mobile partition 12 is now fully transferred and functional on destination server system 11, as if it were transferred as in FIG. 1.

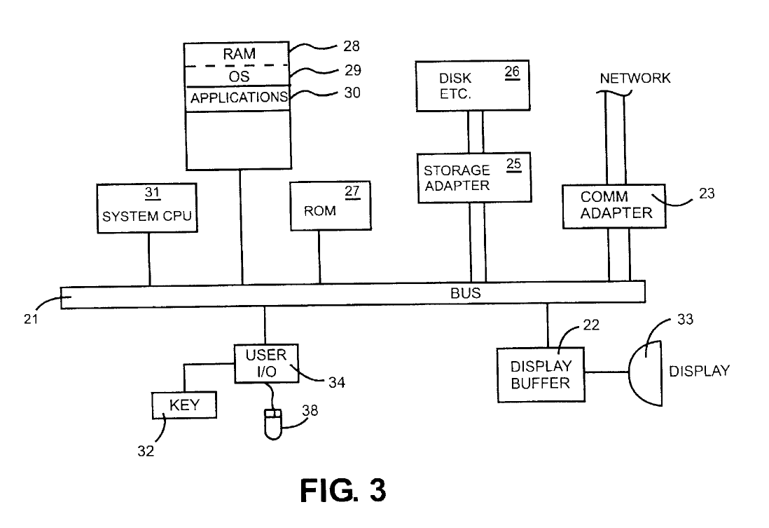

With respect to FIG. 3, there is shown an illustrative diagrammatic view of a control processor that may be used for power hypervisor 13 and 14 of FIGS. 1 and 2. A central processing unit (CPU) 31, such as one of the microprocessors or workstations, e.g. System p™ series, eServerp5, eServer OpenPower™ or the PowerVM Standard edition, available from IBM, is provided and interconnected to various other components by system bus 21. An operating system (OS) 29 (e.g. a Linux System) runs on CPU 31, provides control and is used to coordinate the function of the various components of FIG. 2. Operating system 29 may be one of the commercially available operating systems. Application programs 30, controlled by the system, are moved into and out of the main memory Random Access Memory (RAM) 28. These programming applications may be used to implement functions of the present invention. ROM 27 includes the Basic Input/Output System (BIOS) that controls the basic computer functions of the hypervisor. RAM 28, storage adapter 25 and communications adapter 23 are also interconnected to system bus 21. Storage adapter 25 communicates with the disk storage device 26 of the server system. Communications adapter 23 interconnects bus 21 with the ethernet network. I/O devices are also connected to system bus 21 via user interface adapter 34. Keyboard 32 and mouse 38, when appropriate, may be connected to bus 21 through user interface adapter 34. Display buffer 22 supports an appropriate display 33.

FIG. 3 is a general flowchart of a program set up to implement the present invention for providing an alternative implementation for moving a mobile LPAR from a source server controlled system to a destination server controlled system in a virtual processor system environment wherein the system is divided into LPARs, step 70.

Provision is made for the system determining if both the source and destination server systems involved in an initiated partition move have access to the same SAN, step 71.

If the determination is made that both the source and destination systems have access to the SAN, then provision is made, step 72, for: 1) transmitting the mobile LPAR over a connecting network from the source to the destination server systems through iSCSI protocols, and 2) transmitting all data storage supporting the mobile LPAR via the SAN.

On the other hand, if the determination is made that either server system or both do not have such access to the SAN, then, step 73, provision is made for: 3) creating a mirror image in the source server system of all data storage supporting the mobile LPAR; 4) transmitting this mirror image over a network using iSCSI protocols to local storage associated with the destination system; and 5) also transmitting the mobile LPAR over a connecting network from the source to the destination server systems through iSCSI protocols.

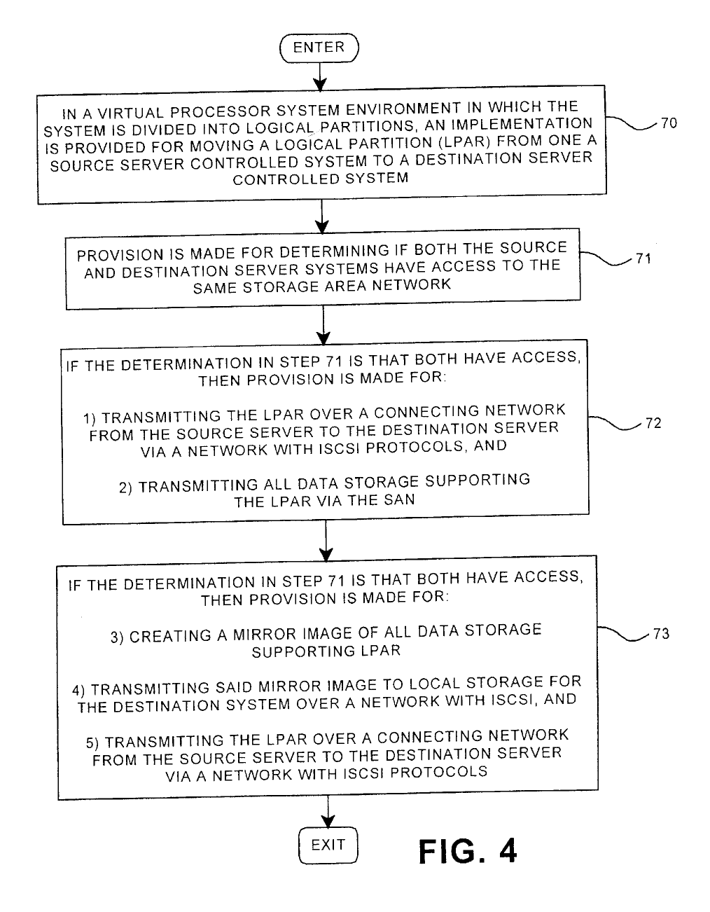

As mentioned hereinabove with respect to the description of FIG. 2, a routine is provided via the hypervisor 14, in destination server system 11, FIG. 2, wherein the destination server accesses the storage supporting mobile partition. This routine will now be described with respect to FIG. 4. Upon a determination, step 81, that either or both the source and destination server systems do not have access to the SAN, provision is made for confirming that local storage associated with the destination server has storage capability for the mirror image of all data storage supporting the LPAR being transferred, step 82. Upon such confirmation, provision is made for the creation of a mirror image of all data storage supporting the LPAR by the destination server treating the LPAR data storage at the source server system as the target device of the destination server from which the mirror image is created, step 83, and then transmitted over a network using iSCSI protocols to the destination server system at which the data storage supporting the transferred LPAR will be stored on the local storage associated with the destination system, step 84.

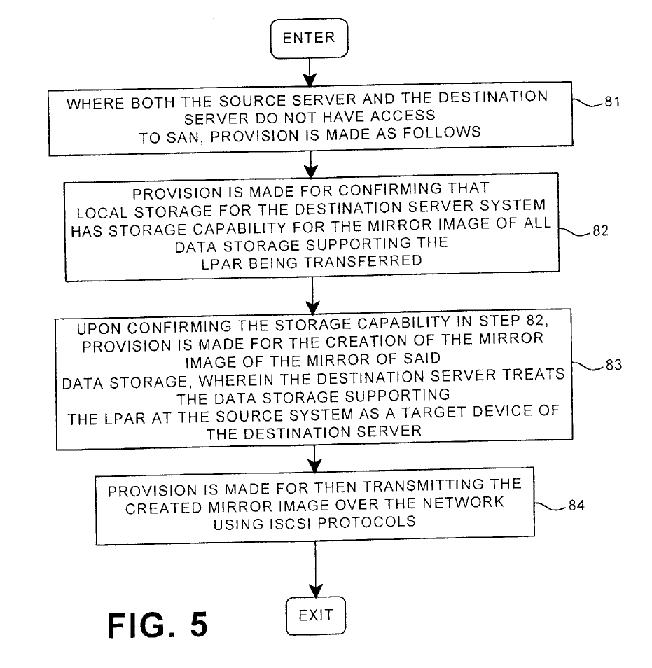

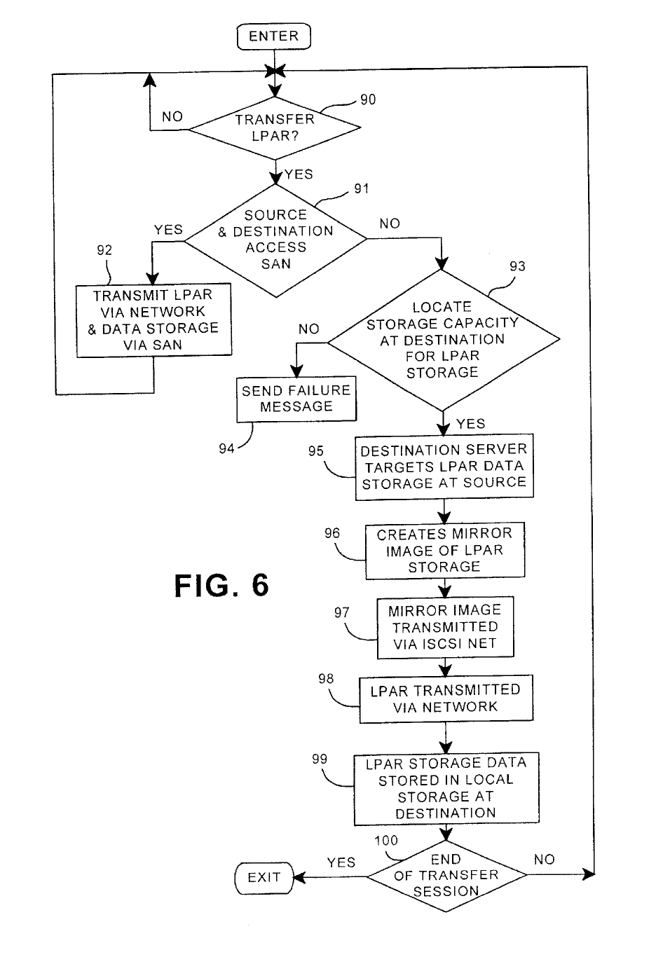

A simple illustrative example of a run of the process set up in FIGS. 4 and 5 will be described with respect to the flowchart of FIG. 6. The system awaits the initiation of a mobile LPAR transfer, step 90. If Yes, a transfer has been initiated, a determination is made, step 91, as to whether both the source and destination server systems have access to a SAN. If Yes, then, step 92, the LPAR is transmitted via the connecting network and the data storage supporting the LPAR is transmitted via the SAN. Upon completion of the transfer, the flow is returned to step 90.

If the determination in step 91 is No, both servers do not have access to SAN, then, step 93, a determination is made as to whether local storage capability can be located at the destination server system for storage of the LPAR supporting data storage. If No, storage cannot be found, then, step 94, a failure message is sent. However, if Yes, local storage is available, then, step 95, the destination server treats the data storage for the LPAR at the source system as a target device and creates a mirror image of the data storage for the LPAR, step 96. The mirror image is transmitted via a network using iSCSI protocols to the destination server, step 97, and the LPAR is transmitted via the connecting network from the source server system to the destination server system, step 98. The storage data supporting the transferred LPAR is stored in the local storage at the destination server wherein the storage is available for the transferred LPAR, step 99. At this point, a determination may conveniently be made, step 100, as to whether the transfer session is at an end. If Yes, the session is exited. If No, the process is returned to step 90.

While the primary implementation of the present invention offers the above-described alternative solution to LPAR transfer systems wherein source and/or destination server systems do not have access to a SAN, there is a further application to some exisitng LPAR transfer systems in which both the source and destination server systems do have access to types of Fibre Channel SANs that have a very limited range of connectability. By way of background, Fibre Channel (FC) is a network technology used to a great extent for storage networks. It is an industry standard technology provided by the International Committee for Information Technology Standards (INCITS) of the American National Standards Institute (ANSI). FC has become a standard connection for server systems having limited ranges of connectability, e.g. systems in the same building or in a limited area facility. In such FC systems, a need may arise for storage transfer over longer distances. In such situations, the alternative implementation of the present invention may be considered as an alternative to the Fibre Channel SAN. In this connection, it should be noted that Fibre Channel Protocol (FCP) uses SCSI commands for its transmissions.

Although certain preferred embodiments have been shown and described, it will be understood that many changes and modifications may be made therein without departing from the scope and intent of the appended claims.

What is claimed is:

1. A method for transferring a logical partition (LPAR) from a source server controlled computer system to a destination server controlled computer system over a connecting network comprising:
determining if said source server system and said destination server system have access to the same storage area network (SAN);
if said source and destination server system have access to the same SAN, then:
transmitting a logical partition (LPAR) over said connecting network from said source server system to said destination server system, and
transmitting all data storage supporting said LPAR from said source server system to said destination server system over said SAN;
if said source and destination server system do not have access to the same SAN, then:
creating a mirror image of said all data storage supporting said LPAR,
transmitting said mirror image of said all data storage supporting said LPAR to local storage supporting said destination server system, and
transmitting a logical partition (LPAR) over said connecting network from said source server system to said destination server system.

2. The method of claim 1, wherein:
said LPAR is transmitted over said connecting network using iSCSI protocols; and
said mirror image of all data storage supporting said LPAR is transmitted over a network using iSCSI protocols.

3. The method of claim 2, further including the step, prior to the creating of said mirror image, of determining that said local storage supporting said destination server system is capable of storing said mirror image.

4. The method of claim 3 wherein said source server and said destination server are Virtual I/O Servers (VIOS).

5. The method of claim 4 wherein said creating and transmitting of said mirror image comprises:
accessing, by said destination server system using iCSCI protocols, said data storage supporting said LPAR wherein said data storage is treated as a target device of said destination server;
creating said mirror image; and
transmitting said mirror image over said network using said iSCSI protocols.

6. The method of claim 5 wherein said network is the Internet.

7. The method of claim 5 wherein said source and destination server systems are Central Electronics Complex (CEC) servers.

8. A computer controlled system for transferring a logical partition (LPAR) from a source server controlled computer system to a destination server controlled computer system over a connecting network, comprising:
a processor; and
a computer memory holding computer program instructions that when executed by the processor perform the method comprising:
determining if said source server system and said destination server system have access to the same storage area network (SAN);
if said source and destination server system have access to the same SAN, then:
transmitting a logical partition (LPAR) over said connecting network from said source server system to said destination server system, and
transmitting all data storage supporting said LPAR from said source server system to said destination server system over said SAN;
if said source and destination server system do not have access to the same SAN, then:
creating a mirror image of said all data storage supporting said LPAR,
transmitting said mirror image of said all data storage supporting said LPAR to local storage supporting said destination server system, and
transmitting a logical partition (LPAR) over said connecting network from said source server system to said destination server system.

9. The system of claim 8 wherein the performed method uses iSCSI protocols to transmit said LPAR over said connecting network; and
said mirror image of all data storage supporting said LPAR is transmitted over a network using iSCSI protocols.

10. The system of claim 9 wherein the performed method further includes the step, prior to the creating of said mirror image, of determining that said local storage supporting said destination server system is capable of storing said mirror image.

11. The system of claim 10 wherein said source server and said destination server are Virtual I/O Servers (VIOS).

12. The system of claim 11 wherein said creating and transmitting of said mirror image by said performed method comprises:
accessing, by said destination server system using iCSCI protocols, said data storage supporting said LPAR wherein said data storage is treated as a target device of said destination server;
creating said mirror image; and
transmitting said mirror image over said network using said iSCSI protocols.

13. The system of claim 12 wherein said network is the Internet.

14. The system of claim 12 wherein said source and destination server systems are Central Electronics Complex (CEC) servers.

15. A computer usable storage medium having stored thereon a computer readable program for transferring a logical partition (LPAR) from a source server controlled computer system to a destination server controlled computer system over a connecting network, wherein the computer readable program when executed on a computer causes the computer to:
determine if said source server system and said destination server system have access to the same storage area network (SAN);
if said source and destination server system have access to the same SAN, then:
transmit a logical partition (LPAR) over said connecting network from said source server system to said destination server system, and
transmit all data storage supporting said LPAR from said source server system to said destination server system over said SAN;
if said source and destination server system do not have access to the same SAN, then:
create a mirror image of said all data storage supporting said LPAR,
transmit said mirror image of said all data storage supporting said LPAR to local storage supporting said destination server system, and
transmit a logical partition (LPAR) over said connecting network from said source server system to said destination server system.

16. The computer usable medium of claim 15, wherein:
said LPAR is transmitted over said connecting network using iSCSI protocols; and
said mirror image of all data storage supporting said LPAR is transmitted over a network using iSCSI protocols.

17. The computer usable medium of claim 16 wherein the computer program when executed further causes the computer, prior to the creating of said mirror image, to determine that said local storage supporting said destination server system is capable of storing said mirror image.

18. The computer usable medium of claim 17 wherein said source server and said destination server are Virtual I/O Servers (VIOS).

19. The computer usable medium of claim 18 wherein the computer program when executed creates and transmits said mirror image by causing the computer to:
access, by said destination server system using iCSCI protocols, said data storage supporting said LPAR wherein said data storage is treated as a target device of said destination server;
create said mirror image; and
transmit said mirror image over said network using said iSCSI protocols.

20. The computer usable medium of claim 19 wherein said network is the Internet.
